(19) United States
(12) Patent Application Publication
(10) Pub. No.: US 2009/0106071 A1
(43) Pub. Date: Apr. 23, 2009

(54) Goal Achievement Manager

(75) Inventor: Manuel Mark, Fortaleza (BR)

Correspondence Address: Rextide, Inc, 9663 Santa Monica Blvd., #444, Beverly Hills, CA, 90210-4303, US

(73) Assignee: Rextide Inc., Beverly Hills, CA (US)

(21) Appl. No.: 12/253,848

(22) Filed: Oct. 17, 2008

Related U.S. Application Data
(60) Provisional application No. 60/981,021, filed on Oct. 18, 2007.

(51) Int. Cl. G06Q 10/00

(52) U.S. Cl. 705/8

(57) ABSTRACT

The present invention relates to a method for controlling, planning, managing and enhancing the progressive achievement of user's future goals. The method allows for comparing and interpreting life-event data provided by the user in connection with his or her expected future achievements within a specific timeframe. It also enables ecommerce opportunities for sponsors and advertisers.

### CROSS-REFERENCE TO RELATED APPLICATIONS

This application claims priority from U.S. Provisional Patent Application Ser. No. 60/981,021, filed on 18 Oct. 2007 and entitled “Goal Achievement Manager” the contents of which are hereby fully incorporated by reference.

### BACKGROUND OF THE INVENTION

1. Field of the Invention

Social networking and online advertising.

2. Description of the Related Art

Social networking websites focus on building online communities of people who share interests and activities, or who are interested in exploring the interests and activities of others. These websites have been around since the middle of the nineties but in recent years, social networking has exploded across the web. The Web 2.0 initiative has made modern social networking sites increasingly popular and easier to use than the initial wave of sites that launched in the nineties. As a result, social networking websites are used by hundreds of millions of people around the world nowadays.

Due to the widespread use and popularity of such websites, a new form of advertising that is growing rapidly is social network advertising. It is online advertising with a focus on social networking sites. Despite of being a relatively immature market, social networking advertising has been growing strongly in recent years as advertisers are willing to take advantage of the information provided by users.

Thus, there is a need to create new methods of processing and taking advantage of the information input by users in social networking websites. Therefore, the present invention provides an innovative method of monitoring the achievement of goals of users interacting with other users in a social networking website while processing their input data to advertise products or services directed to contribute to the achievement of such goals.

### DETAILED DESCRIPTION OF THE INVENTION

The method consists of using life event data of a website user (hereafter: the “user”) stored on dayboox.com (hereafter: the “website”) to monitor the achievement of user's predetermined goals within a specific timeframe. The user inputs information to the website on past life-events with the desired regularity. This information is organized in a way that allows for creating a digital journal of user's life. In doing so, events occurred in user's life are tracked on the website where they remain indefinitely stored. Complementary, the user inputs information to the website regarding future objectives, aims and goals to be achieved in the short, middle and long term. This information is stored, processed, and managed by the so-called goal achievement manager. Generally, the goal achievement manager allows for storing, sorting, processing user's data and tracking the partial or fully achievement of user's goals.

Information provided by the user to create the digital journal on the website may comprise any kind of electronic files, like but not limited to, music, videos, images, and photos. The user may also upload information about past life-events through text entries to the website. As explained in the paragraph above, the user not only creates a digital journal on the website but also stores his or her upcoming goals thereon. In this specification, the terms upcoming goal, goal, future objective or aim are used irrespectively and mean the object of a person's ambition or effort, a desired result to be achieved within a specific period of time. The goal achievement manager processes user's information to determine whether user's goals have been partial or fully achieved within a specific timeframe. For this purpose, the goal achievement manager uses the step-by-step goal achievement road application (hereafter: the “goal achievement road”). Therein, each of the single steps or procedures needed to achieve a main goal are showed in a timeline. For example, user's final goal is to acquire real state property consisting of determined characteristics, in a certain area of the city, within a specific period of time. By the way of example only, if the user acquires real state comprising less of the desired characteristics but in the desired area of the city and before the corresponding timeframe expires, the goal is considered partially achieved.

The goal achievement manager determines when the user fails to perform one or more independent steps proposed in the goal achievement road to achieve the main goal. In this case, the goal achievement manager sends an alarm to the user for the delay or failure to perform such steps. These alarms may consist of, without being limited to, SMSs, emails, or “pop-up” windows showed every time the user logs into the website.

The goal achievement manager also compares similar goals from different users in a network. This comparison feature is set by the user who has previously joint one or more networks of the website. After joining a network, the user predefines the parameters under which the goal achievement manager should compare his or her goals with another user's goals. The main parameter relates to comparable goals to be achieved within the same timeframe. For example, user A and user B want to acquire a real state property in country C in the middle term. The user may also introduce complementary parameters. One complementary parameter can be user's age. Then, the system compares user A with other users of the same age, or of a similar age group who set the goal of buying real state property in country C in the middle term. Another parameter may be user's occupation. In this example, user A has the same occupation of user B. User A and user B share the common goal of obtaining a salary or income increase within an specific period of time. The goal achievement manager keeps users up-to-date informing when any other of the compared users achieve the goal. If so authorised, the history of the achievement of user's goal may be published in a top list of achievements on the website.

The goal achievement manager also allows the user to choose among different privacy settings in relation to the information stored on the website. For example, in a highest protection level, the user may decide that very personal goals or goals achievement roads are only viewed by relatives or spouses. Similarly, the history of goals achieved in the past as well as other user's ratings of the achievement of user's goal may be part of a private record only accessed for a limited number of authorised users. The user may also decide to belong to different networks. Each network represents a group of interest. In this case, the goal achievement manager allows the user to decide which information should be shared with users of the network. The lowest protection level is the public record. In this level, any of the website's users are allowed to access the user's information. It should be understood that the privacy protection levels mentioned above are provided by way of example only and that the goal achievement manager may allow the user to choose between several security levels.

The method allows for searching and collecting data available in the internet that may be relevant to the achievement of user's goals. Generally, the collected data provides guide about how to achieve user's goal(s). It also focuses on keeping the user informed about the latest developments and news related to user's goal(s). For example, if user's goal is to acquire a real state property in a specific country in Europe, the method allows for finding information on the real state market in that specific country. Then, all relevant information is sent to the user like, but not limited to, real state market crashes or bubbles, increase or diminution of interest rates, standard lending conditions in the specific market, etc.

The method also allows for researching, interpreting, and creating patterns or categorizations of user's goals. For example, goals A, B and C of the user relate to the achievement of victories on sport competitions while goal D relates to learn the use of an specific software application. The method allows for interpreting this data determining a primary interest of the user in sport, and a secondary interest in informatics. Subsequently, the user receives relevant information related to that primary and secondary interest i.e. newsgroups information, blogs information, specialized websites, press articles, etc. Searching of this information focuses on statistically desirable material for example by monitoring bookmarking activities of the website users. The method also allows for using this processed information to advertise products or services considered to be of interest to the user. It should be understood that the interpretation parameter mentioned above is provided by way of example only and that the goal achievement manager may use several parameters when interpreting and processing user's data to send relevant information or advertise products or services.

Users can comment on another user's life and rate it at different levels of success. The user authorizes to receive another user's comments on his or her achievement's history. If so, a record of the comments can be accessed or deleted at any time. In the same way, a record of past or current ratings can be viewed at anytime on the website. Current ratings are updated in real time.

Additionally, the user may also request other users to be part of his or her advising network. The user creates an advising network in relation to a specific goal. The network is intended to provide the user with advice consisting of knowledge about how to achieve the specific goal. For example, a law student may create a network of law professionals to obtain advice about how to pass a specific state examination.

As explained above, aspects of this invention pertain to specific “method functions” to be implemented on computer systems. In an alternate embodiment, the goal achievement manager may be implemented as a computer program product for use with web services similar to dayboox.com.

What is claimed is:

1. A method of monitoring the achievement of future objectives of a website user, comprising the steps of:
a) providing a website, said website having network functionalities, said website providing a digital journal application, said website providing a step-by-step achievement road application, said website being accessed through a web or mobile interface;
b) storing user data on daily events in said digital journal, said digital journal storing, sorting and processing said user data chronologically;
c) storing user data about at least one future objective in said step-by-step achievement road application; said application consisting of a timeline indicating single events, steps and procedures proposed by the user to achieve an objective within a determined timeframe, said application allowing to monitor the compliance, delay or failure to achieve said objective wholly or partially;
d) generating a notification of success to the user when said objective is partially or wholly achieved;
e) generating alarms in case of failure or delay to perform any steps of the achievement road;
f) comparing similar objectives of different website users, said comparison being performed according to parameters predetermined by the user, wherein the user is notified when any of the compared users achieve a similar objective;
g) processing user data stored on the digital journal to automatically determine the full or partial achievement of user proposed objectives in the step-by-step achievement road;
h) allowing only authorised users to access information relating user's future objectives; and;
i) allowing users to create an advising network, said advising network being related to an specific future objective of the user, said advising network consisting of other website's users expressly invited by the user, said website users being able to add events, steps or procedures to the achievement road regarding said future objective; wherein users may also add members to said advised network based on recommendations of membership generated by the website.

2. The method of claim 1, further including the collection of data available in Internet relating to future objectives of the user, said collected information being provided to the user in regular basis according to user's website settings.

3. The method of claim 1, further including processing of the information provided by the user in order to determine preferences, behaviour patterns or needs, said processed information used to advertise products or services of interest to the user to achieve their future objectives.
